(19) United States
(12) Patent Application Publication
(10) Pub. No.: US 2005/0086037 A1
(43) Pub. Date: Apr. 21, 2005

(54) Memory device load simulator

(76) Inventors: Robert S. Pauley, Mission Viejo, CA (US); Jayesh R. Bhakta, Cerritos, CA (US); William M. Gervasi, Ladera Ranch, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/953,481

(22) Filed: Sep. 29, 2004

Related U.S. Application Data
(60) Provisional application No. 60/507,193, filed on Sep. 29, 2003.
(60) Provisional application No. 60/605,699, filed on Aug. 30, 2004.

(51) Int. Cl. G06F 17/50

(52) U.S. Cl. 703/14

(57) ABSTRACT

A load simulator is configured to simulate a load characteristic of at least one memory device. The memory device has a plurality of device contacts configured to be electrically coupled to a plurality of module contacts on a printed circuit board of a memory module. Each device contact has a load capacitance. The load simulator includes a package having a first face and a plurality of simulator contacts on the first face. The simulator contacts are configured to be electrically coupled to the module contacts. Each simulator contact has a simulator capacitance approximately equal to the load capacitance of a corresponding device contact of the at least one memory device.

### CLAIM OF PRIORITY

The present application claims the benefit of U.S. Provisional Application No. 60/507,193, filed Sep. 29, 2003 and U.S. Provisional Application No. 60/605,699, filed Aug. 30, 2004, both of which are incorporated in their entireties by reference herein.

### BACKGROUND OF THE INVENTION

1. Field of the Invention

The present invention relates to methods and components used to configure memory modules for use in computers.

2. Description of the Related Art

For accurate measurements of signal quality, a test probe is typically placed close to the input terminal of the destination device or component. If the probe is not attached close to the input terminal of the device, then the measurement is not an accurate representation of the true behavior of the signal at the input terminal of the device.

For example, devices with ball-grid-array (BGA) or micro-ball-grid-array (μBGA) configurations utilize solder balls as input terminals. These solder balls are positioned underneath the device, so it is extremely difficult, if not impossible, to attach instrument probes to measure signals at the input terminals (balls) of the BGA or μBGA devices.

### SUMMARY OF THE INVENTION

In certain embodiments, a load simulator is configured to simulate a load characteristic of at least one memory device. The memory device has a plurality of device contacts configured to be electrically coupled to a plurality of module contacts on a printed circuit board of a memory module. Each device contact has a load capacitance. The load simulator comprises a package having a first face and a plurality of simulator contacts on the first face. The simulator contacts are configured to be electrically coupled to the module contacts. Each simulator contact has a simulator capacitance approximately equal to the load capacitance of a corresponding device contact of the at least one memory device.

In certain embodiments, a load simulator is configured to simulate the load characteristics of at least one memory device. The memory device has a plurality of device contacts configured to be electrically coupled to a plurality of conductive lines of a printed circuit board of a memory module. Each device contact has a load capacitance. The load simulator comprises a plurality of embedded capacitors in the printed circuit board. Each embedded capacitor is electrically coupled to a conductive line of the printed circuit board. Each embedded capacitor has a capacitance approximately equal to the load capacitance of a corresponding device contact of the at least one memory device.

In certain embodiments, a method tests a memory module having a printed circuit board and a plurality of memory devices mounted on the printed circuit board. Each memory device has a plurality of device contacts electrically coupled to the printed circuit board with each device contact having a load capacitance. The method comprises providing a load simulator which comprises a package having a first face and a second face. The load simulator further comprises a plurality of access points on the first face. The load simulator further comprises a plurality of simulator contacts on the second face. Each simulator contact is electrically coupled to a corresponding access point. Each simulator contact has a simulator capacitance approximately equal to the load capacitance of a corresponding device contact of the memory device. The method further comprises electrically coupling the plurality of simulator contacts to the printed circuit board. The method further comprises measuring electrical signals from the memory module at the plurality of access points.

In certain embodiments, a memory module has a first bit width and comprises a first number of memory devices. The memory module further comprises a printed circuit board optimized for use with a second number of memory devices to form a second bit width greater than the first bit width. The first number of memory devices is electrically coupled to the printed circuit board. The memory module further comprises at least one load simulator electrically coupled to the printed circuit board. The load simulator has a load approximately equal to a load of a third number of memory devices. The second number is equal to a sum of the first number and the third number.

### BRIEF DESCRIPTION OF THE DRAWINGS

FIGS. 1A and 1C schematically illustrate an embodiment of a load simulator.

FIG. 1B schematically illustrates a memory device and a memory module in accordance with embodiments described herein.

FIG. 1D schematically illustrates an embodiment of a load simulator electrically coupled to the conductive lines of a memory module.

FIG. 2 schematically illustrates an exemplary load simulator which is configured to simulate a load characteristic of a DDR1 memory device.

FIG. 3 schematically illustrates an exemplary load simulator which is configured to simulate a load characteristic of a DDR2 memory device.

FIGS. 4A and 4B schematically illustrate an embodiment of a load simulator comprising a package with a first face with a plurality of simulator contacts, and a second face with a plurality of access points.

FIG. 5A schematically illustrates an embodiment of a load simulator embedded within the printed circuit board of the memory module.

FIG. 5B schematically illustrates an embodiment of a load simulator embedded within the printed circuit board and having a plurality of access points.

FIG. 6 schematically illustrates two views of a typical memory module with a first side and a second side.

FIG. 7 schematically illustrates a load simulator installed in place of one of the memory devices of the rank of memory on the first side of the memory module and in place of one of the memory devices of the rank of memory on the second side of the memory module.

FIG. 8 schematically illustrates load simulators installed in place of each of the memory devices of the rank of memory on the second side of the memory module.

FIG. 9A schematically illustrates a load simulator stacked with a memory device on a memory module with an interconnect assembly electrically coupling the load simulator to the memory device.

FIG. 9B schematically illustrates a load simulator stacked with a memory device using an interconnect assembly which comprises an interposer.

FIG. 10 schematically illlustrates an exemplary circuit of a load simulator for simulating on-die termination (ODT) of a DDR2 memory device.

FIG. 11A schematically illustrates the slew rate mismatch between an exemplary 9-load dual in-line memory module (DIMM) and an 18-load DIMM.

FIG. 11B schematically illustrates the slew rates for a 9-load DIMM with trace length adjustments as compared to the 18-load DIMM of FIG. 11A.

FIG. 12A schematically illustrates a lightly-loaded memory module with a load simulator in accordance with embodiments described herein.

FIG. 12B schematically illustrates a medium-loaded memory module with a load simulator in accordance with embodiments described herein.

FIG. 12C schematically illustrates a heavily-loaded memory module with 16 memory devices, with two ranks of eight memory devices on each of two sides of the memory module.

FIG. 13 schematically illustrates the slew rates for the 9-load DIMM with a load simulator as compared to the 18-load DIMM of FIG. 11A.

FIG. 14 schematically illustrates an exemplary embodiment of a memory module with a first bit width of 64 bits that includes eight memory devices.

FIG. 15A schematically illustrates a memory module having a plurality of memory devices such that the loads are not balanced on either side of the register.

FIG. 15B schematically illustrates one embodiment of a memory module in which at least one load simulator is used to balance the loads on the two sides of the register.

### DETAILED DESCRIPTION OF THE PREFERRED EMBODIMENT

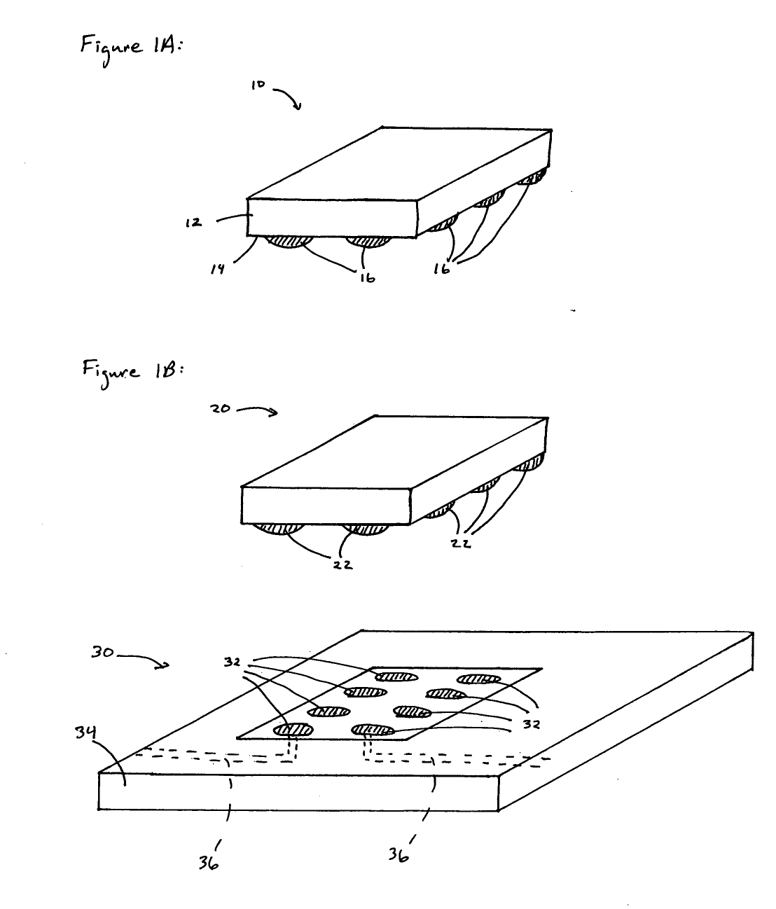

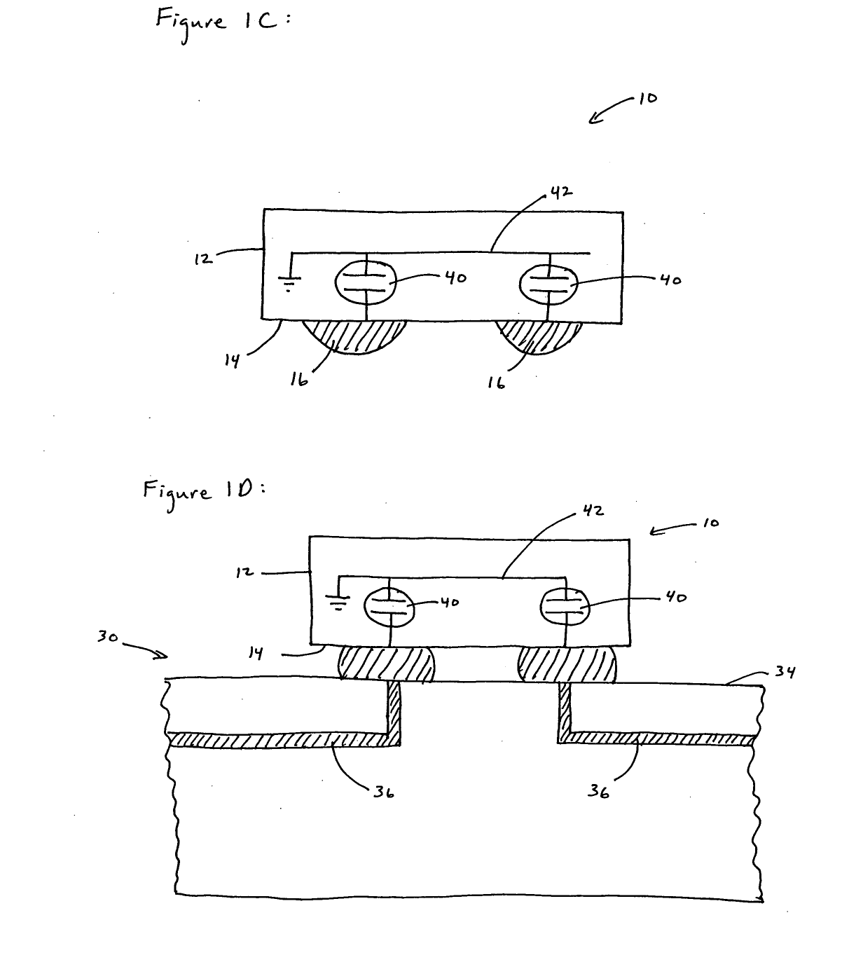

FIG. 1A schematically illustrates a load simulator 10 in accordance with embodiments described herein. The load simulator 10 is configured to simulate a load characteristic of at least one memory device 20 (an example of which is schematically illustrated by FIG. 1B). The load simulator 10 comprises a package 12 having a first face 14. The load simulator 10 further comprises a plurality of simulator contacts 16 on the first face 14. Each simulator contact 16 has a corresponding simulator capacitance.

In certain embodiments, the package 12 comprises a printed circuit board, and in other embodiments, the package 12 comprises an encapsulated integrated circuit package. The package 12 of certain embodiments has a generally rectangular shape, but other shapes are compatible with embodiments described herein. The first face 14 of certain embodiments is generally planar, but other forms of the first face 14 (e.g., stepped, angled, or curved) are also compatible with embodiments described herein. In certain embodiments, the simulator contacts 16 comprise solder balls, pins, pads, or other forms of conductive terminals.

The simulator contacts 16 are configured to be electrically coupled to a plurality of module contacts 32 on a printed circuit board 34 of a memory module 30, schematically illustrated by FIG. 1B. The module contacts 32 are electrically coupled to corresponding conductive lines 36 in the printed circuit board 34. In certain embodiments, the conductive lines 36 comprise signal lines, address lines, and voltage lines which route the corresponding signals and voltages to the module contacts 32 and to either the device contacts 22 or the simulator contacts 16 mounted thereon. In certain embodiments, the module contacts 32 comprise solder balls, pins, pads, or other forms of conductive terminals.

In certain embodiments, the plurality of simulator contacts 16 and the plurality of module contacts 32 are compatible with a ball-grid-array (BGA) configuration. In other embodiments, the plurality of simulator contacts 16 and the plurality of module contacts 32 are compatible with a micro-ball-grid-array (μBGA) configuration. In still other embodiments, the plurality of simulator contacts 16 and the plurality of module contacts 32 are compatible with a thin small-outline package (TSOP) configuration. Other configurations are also compatible with embodiments described herein.

Memory modules 30 compatible with embodiments described herein include, but are not limited to in-line memory modules, dual in-line memory modules (DIMMs), small-outline dual in-line memory modules (SO-DIMMs), mini dual in-line memory modules (Mini-DIMMs), and micro dual in-line memory modules (Micro-DIMMs). The memory module 30 comprises a plurality of module contacts 32 configured to receive either the simulator contacts 16 of the load simulator 10 or the device contacts 22 of the memory device 20.

The memory device 20 schematically illustrated by FIG. 1B has a plurality of device contacts 22. The device contacts 22 are configured to be electrically coupled to the plurality of module contacts 32 on the printed circuit board 34 of the memory module 30. Each device contact 22 of the memory device 20 has a load capacitance. In certain embodiments, the device contacts 22 comprise signal input/output terminals, address input terminals, and voltage input terminals. In certain embodiments, the device contacts 22 comprise solder balls, pins, pads, or other forms of conductive terminals.

In certain embodiments, the memory device 20 comprises a dynamic random-access memory (DRAM) device. The memory device 20 of certain embodiments comprises a dual-data-rate-1 (DDR1) memory device, while the memory device 20 of other embodiments comprises a dual-data-rate-2 (DDR2) memory device. Other types of memory devices 20 which are compatible with embodiments described herein, include but are not limited to, random-access memory (RAM), synchronous-dynamic-random-access memory (SDRAM), double-data-rate-3 (DDR3) memory, and read-only memory.

As described above, each device contact 22 of the memory device 20 has a load capacitance. In certain embodiments, each device contact 22 has the same load capacitance. In certain other embodiments, each device contact 22 of a first set of device contacts 22 has a first load capacitance and each device contact 22 of a second set of device contacts 22 has a second load capacitance different from the first load capacitance. For example, in certain embodiments, each signal input/output terminal of the device contacts 22 has a first load capacitance, and each address terminal of the device contacts 22 has a second load capacitance.

When the memory device 20 is mounted onto the memory module 30, the device contacts 22 are electrically coupled to the module contacts 32 and the signal lines and address lines of the memory module 30 are each electrically coupled to the load capacitances of the device contacts 22. Each simulator contact 16 of the load simulator 10 has a corresponding simulator capacitance. In certain embodiments, the simulator capacitance of each simulator contact 16 is approximately equal to the load capacitance of a corresponding device contact 22 of the memory device 20, thereby simulating the load capacitance of the memory device 20. In other embodiments, the simulator capacitance of each simulator contact 16 is approximately equal to a sum of the load capacitances of the corresponding device contacts 22 of a plurality of memory devices 20, thereby simulating the load capacitances of the plurality of memory devices 20.

When the load simulator 10 is mounted onto the memory module 30, the simulator contacts 16 are electrically coupled to the module contacts 32, and the signal lines and address lines of the memory module 30 are each electrically coupled to the corresponding simulator capacitance. Thus, in certain embodiments, regardless of whether the memory device 20 is mounted onto the memory module 30 or the load simulator 10 is mounted onto the memory module 30, the signal lines and the address lines of the memory module 30 are electrically coupled to the same corresponding capacitances. In this way, certain embodiments of the load simulator 10 are configured to simulate a load characteristic of at least one memory device 20.

In certain embodiments, the load simulator 10 comprises a plurality of embedded capacitors 40, as schematically illustrated by FIG. 1C. At least some of the embedded capacitors 40 are electrically coupled to a voltage plane 42 (e.g., ground or a power voltage) and to the simulator contacts 16 corresponding to the signal input/output terminals of the device contacts 22. For each of these simulator contacts 16, the capacitance of the embedded capacitor 40 is approximately equal to a nominal loading capacitance of the corresponding signal input/output terminal of the device contacts 22. In certain embodiments, at least some of the embedded capacitors 40 are electrically coupled to a voltage plane 42 (e.g., ground or a power voltage) and to the simulator contacts 16 corresponding to the address input terminals of the device contacts 22. For each of these simulator contacts 16, the capacitance of the embedded capacitor 40 is approximately equal to a nominal loading capacitance of the corresponding address input terminal of the device contacts 22.

The load simulator 10 of certain embodiments is mounted on the memory module 30 in place of the memory device 20. As schematically illustrated by FIG. 1D, each embedded capacitor 40 is electrically coupled to a corresponding conductive line 36 in the printed circuit board 34. By simulating the capacitances of the device contacts 22 in this way, the load simulator 10 of certain embodiments can be mounted on a memory module 30 in place of a memory device 20, to simulate the load capacitances of the memory device 20.

In certain embodiments, the embedded capacitors 40 of the load simulator 10 comprise two planar conductors (e.g., copper) spaced by a thin dielectric material. In certain embodiments, the dielectric material comprises ceramic-filled photodielectric (CFP). Such embedded capacitors 40 are fabricated by various techniques, including but not limited to those disclosed by U.S. Pat. No. 6,349,456, which is incorporated in its entirety by reference herein.

In certain embodiments, the load simulator 10 further comprises a plurality of embedded resistors electrically coupled to the plurality of simulator contacts 16. In certain embodiments, the load simulator 10 further comprises a plurality of embedded inductors electrically coupled to the plurality of simulator contacts 16. By combining embedded capacitors with embedded resistors and/or embedded inductors, certain embodiments advantageously provide a load simulator 10 which more closely simulates the load characteristics of the memory module 20. Such embedded capacitors, embedded resistors, and embedded inductors can be fabricated using known techniques, including but not limited to those disclosed by U.S. Pat. Nos. 5,912,507; 5,994,997; 6,103,134; 6,108,212; 6,130,601; 6,171,921; 6,194,990; 6,225,035; 6,229,098; 6,232,042; 6,256,866; 6,342,164; and 6,440,318. Each of these patents is incorporated in its entirety by reference herein. Materials for manufacturing printed circuit boards comprising embedded passive components are available from Gould Electronics, Inc., of Eastlake, Ohio, and from Ohmega Technologies, Inc., of Culver City, Calif.

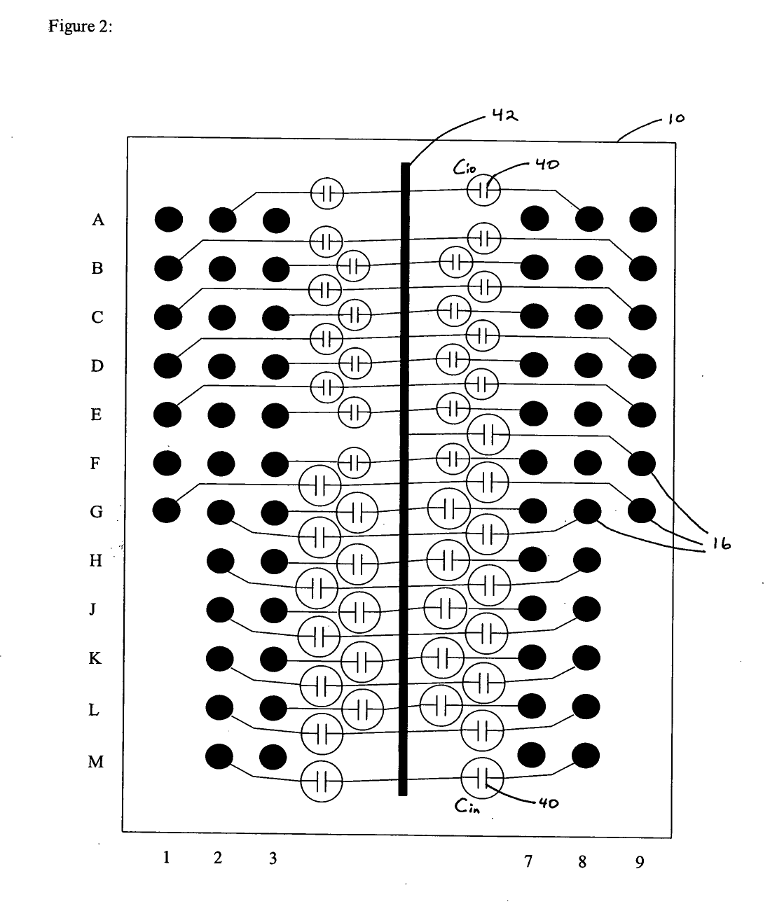

FIG. 2 schematically illustrates an exemplary load simulator 10 which is configured to simulate a load characteristic of a DDR1 memory device. The simulator contacts 16 comprise solder balls which are arranged in an array which is compatible with a BGA configuration in accordance with a standard footprint as described by Publication MO-233C, February 2003, of the Joint Electron Device Engineering Council (JEDEC), which is incorporated in its entirety by reference herein. The embodiment schematically illustrated by FIG. 2 is compatible with Variation AA of Publication MO-233C, while other embodiments are compatible with other variations. The footprint of the load simulator 10 of FIG. 2 is approximately 8 millimeters by 13 millimeters, and the thickness of the load simulator 10 is approximately 1 millimeter.

The simulator contacts 16 of the load simulator 10 correspond to the device contacts 22 of the DDR1 memory device 20 being simulated. The embodiment schematically illustrated by FIG. 2 corresponds to a “×16” (“by 16”) organized DDR1 memory device. Other load simulators 10 which simulate “×8” or “×4” organized DDR1 memory devices are also compatible with embodiments described herein.

In certain embodiments, each simulator contact 16 has a capacitance which is approximately equal to a capacitance of the corresponding device contact 22 of the memory device 20. Table 1 lists the assignments of the various data input/output terminals, address input terminals, and voltage terminals for the device contacts 22 of an exemplary DDR1 memory device being simulated by the load simulator 10 of FIG. 2. In certain embodiments, the simulator contacts 16 corresponding to the data input/output terminals of the DDR1 memory device 20 each has a simulator capacitance Cᵢₒ (shown in small circles as capacitors 40 in FIG. 2) to a voltage plane 42 corresponding to a common voltage (e.g., ground or VSS). In certain embodiments, as schematically illustrated by FIG. 2, the simulator contacts 16 corresponding to the address terminals of the DDR1 memory device 20 each has a simulator capacitance Cᵢₙ (shown in large circles as capacitors 40 in FIG. 2) to a voltage plane 42 corresponding to a common voltage (e.g., ground or VSS). The values of Cᵢₒ and Cᵢₙ are selected in such embodiments to be approximately equal to corresponding capacitances of the terminals of the DDR1 memory device being simulated. In certain embodiments in which a DDR1 SDRAM device with a data rate of 400 MHz is being simulated, Cᵢₒ is approximately equal to 4 picofarads and Cᵢₙ is approximately equal to 2 picofarads.

TABLE 1
DDR1 Memory Device (Assignment: capacitance)

| | 1 | 2 | 3 | 7 | 8 | 9 |
|---|---|---|---|---|---|---|
| A | VSSQ | DQ15: Cᵢₒ | VSS | VDD | DQ0: Cᵢₒ | VDDQ |
| B | DQ1: Cᵢₒ | VDDQ | DQ13: Cᵢₒ | DQ2: Cᵢₒ | VSSQ | DQ1: Cᵢₒ |
| C | DQ12: Cᵢₒ | VSSQ | DQ11: Cᵢₒ | DQ4: Cᵢₒ | VDDQ | DQ3: Cᵢₒ |
| D | DQ10: Cᵢₒ | VDDQ | DQ9: Cᵢₒ | DQ6: Cᵢₒ | VSSQ | DQ5: Cᵢₒ |
| E | DQ8: Cᵢₒ | VSSQ | UDQS: Cᵢₒ | LDQS: Cᵢₒ | VDDQ | DQ7: Cᵢₒ |
| F | VREF | VSS | UDM: Cᵢₒ | LDM: Cᵢₒ | VDD | A13, SC: Cᵢₙ |
| G | CKE1: Cᵢₙ | CK: Cᵢₙ | CK#: Cᵢₙ | WE#: Cᵢₙ | CAS#: Cᵢₙ | CS1#: Cᵢₙ |
| H | | A12, NC: Cᵢₙ | CKE0: Cᵢₙ | RAS#: Cᵢₙ | CS0#: Cᵢₙ | |
| J | | A11: Cᵢₙ | A9: Cᵢₙ | BA1: Cᵢₙ | BA0: Cᵢₙ | |
| K | | A8: Cᵢₙ | A7: Cᵢₙ | A0: Cᵢₙ | A10/AP: Cᵢₙ | |
| L | | A6: Cᵢₙ | A5: Cᵢₙ | A2: Cᵢₙ | A1: Cᵢₙ | |
| M | | A4: Cᵢₙ | VSS | VDD | A3: Cᵢₙ | |

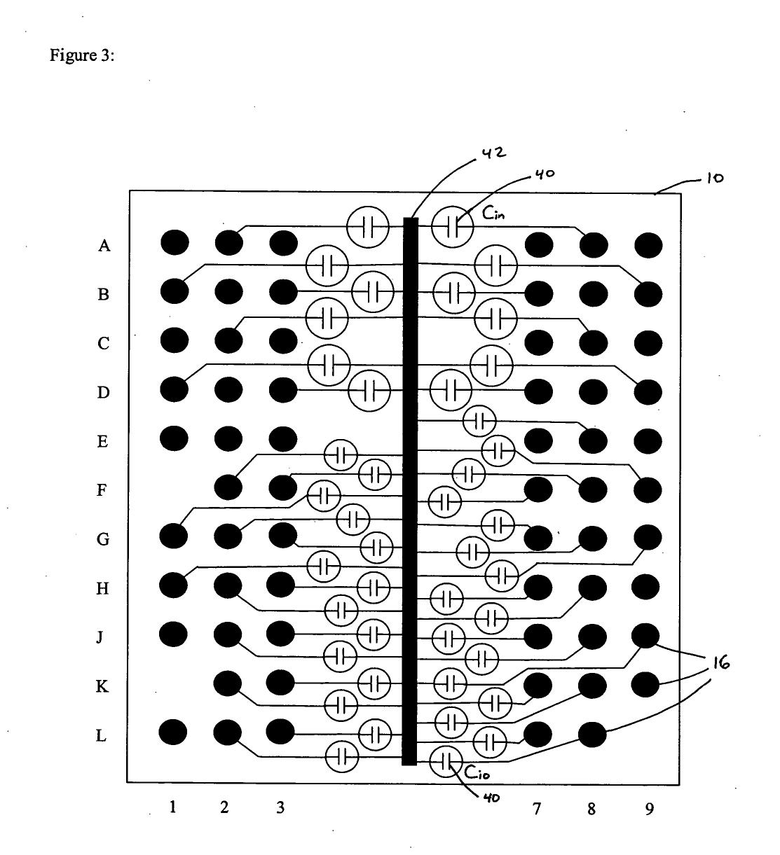

FIG. 3 schematically illustrates an exemplary load simulator 10 which is configured to simulate a load characteristic of a DDR2 memory device. The simulator contacts 16 comprise solder balls which are arranged in an array which is compatible with a BGA configuration in accordance with a standard footprint as described by Publication MO-207I, April 2004, of the Joint Electron Device Engineering Council (JEDEC), which is incorporated in its entirety by reference herein. The embodiment schematically illustrated by FIG. 3 is compatible with Variation DJ-z of Publication MO-207I, while other embodiments are compatible with other variations. The footprint of the load simulator 10 of FIG. 3 is approximately 11.6 millimeters by 14 millimeters, and the thickness of the load simulator 10 is approximately 1 millimeter.

The simulator contacts 16 of the load simulator 10 correspond to the device contacts 22 of the DDR2 memory device 20 being simulated. The embodiment schematically illustrated by FIG. 3 corresponds to a “×8” organized DDR2 memory device. Other load simulators 10 which simulate “×4” or “×16” organized DDR2 memory devices are also compatible with embodiments described herein.

In certain embodiments, the simulator contacts 16 each have a capacitance which is approximately equal to a capacitance of the corresponding device contact 22 of the DDR2 memory device 20. Table 2 lists the assignments of the various data input/output terminals, address input terminals, and voltage terminals for the device contacts 22 of an exemplary “×8” DDR2 memory device being simulated by the load simulator 10 of FIG. 3. In certain embodiments, the simulator contacts 16 corresponding to the data input/output terminals of the DDR2 memory device 20 each have a simulator capacitance Cᵢₒ (shown in small circles as capacitors 40 in FIG. 3) to a voltage plane 42 of a common voltage (e.g., ground or VSS). In certain embodiments, the simulator contacts 16 corresponding to the address terminals of the DDR2 memory device 20 each have a simulator capacitance Cᵢₙ (shown in large circles as capacitors 40 in FIG. 3) to a voltage plane 42 of a common voltage (e.g., ground or VSS). The values of Cᵢₒ and Cᵢₙ are selected in certain embodiments to be approximately equal to corresponding capacitances of the terminals of the DDR2 memory device being simulated. In certain embodiments in which a DDR2 SDRAM device with a data rate of 400 MHz is being simulated, Cᵢₒ is approximately equal to 3.25 picofarads and Cᵢₙ is approximately equal to 1.5 picofarads.

TABLE 2
DDR2 Memory Device (Assignment: capacitance)

| | 1 | 2 | 3 | 7 | 8 | 9 |
|---|---|---|---|---|---|---|
| A | VDD | RDQS#: Cᵢₒ | VSS | VSSQ | DQS#: Cᵢₒ | VDDQ |
| B | DQ6: Cᵢₒ | VSSQ | DM/RDQS: Cᵢₒ | LDQS: Cᵢₒ | VSSQ | DQ7: Cᵢₒ |
| C | VDDQ | DQ1: Cᵢₒ | VDDQ | VDDQ | DQ0: Cᵢₒ | VDDQ |
| D | DQ4: Cᵢₒ | VSSQ | DQ3: Cᵢₒ | DQ2: Cᵢₒ | VSSQ | DQ5: Cᵢₒ |
| E | VDDL | VREF | VSS | VSSDL | CK: Cᵢₙ | VDD |
| F | | CKE0: Cᵢₙ | WE#: Cᵢₙ | RAS#: Cᵢₙ | CK#: Cᵢₙ | ODT0: Cᵢₙ |
| G | BA2: Cᵢₙ | BA0: Cᵢₙ | BA1: Cᵢₙ | CAS#: Cᵢₙ | CS0#: Cᵢₙ | CS1#: Cᵢₙ |
| H | CKE1: Cᵢₙ | A10/AP: Cᵢₙ | A1: Cᵢₙ | A2: Cᵢₙ | A0: Cᵢₙ | VDD |
| J | VSS | A3: Cᵢₙ | A5: Cᵢₙ | A6: Cᵢₙ | A4: Cᵢₙ | ODT1: Cᵢₙ |
| K | | A7: Cᵢₙ | A9: Cᵢₙ | A11: Cᵢₙ | A8: Cᵢₙ | VSS |
| L | VDD | A12: Cᵢₙ | A14: Cᵢₙ | A15: Cᵢₙ | A13: Cᵢₙ | |

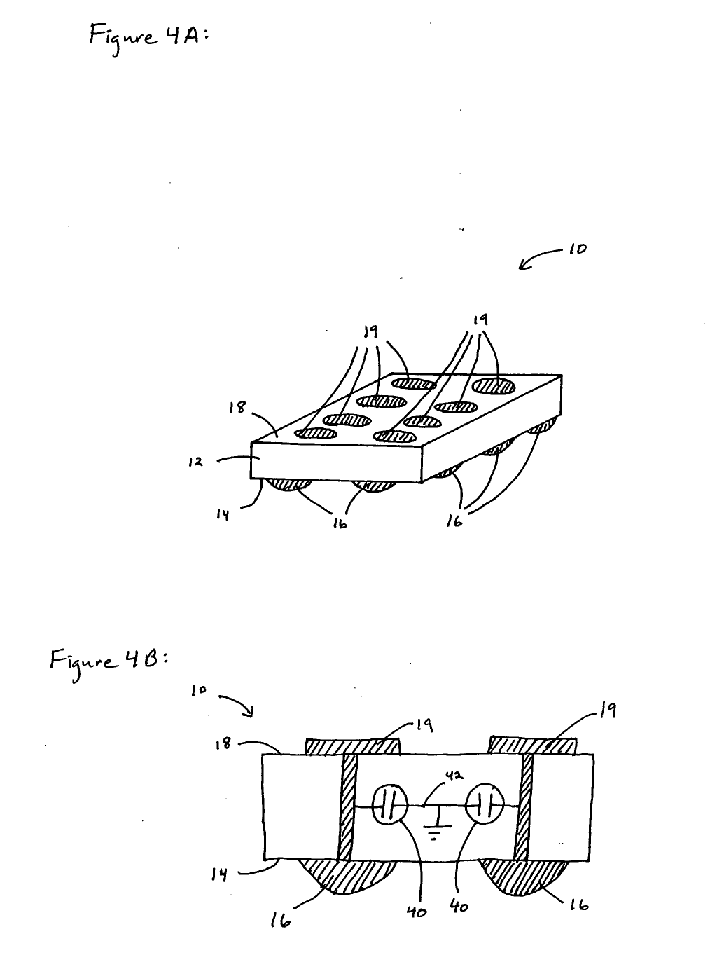

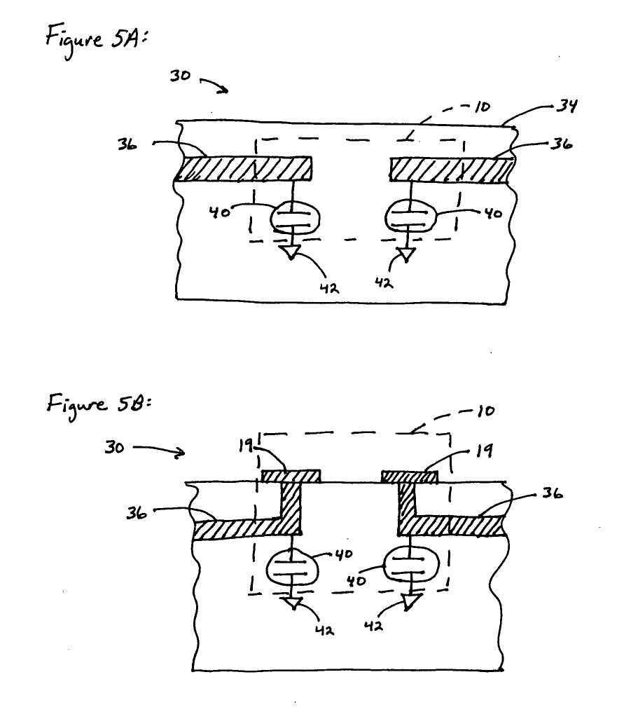

FIGS. 4A and 4B schematically illustrate an embodiment of a load simulator 10 comprising a package 12 with a first face 14 with a plurality of simulator contacts 16 on the first face 14. The load simulator 10 further comprises a second face 18 and a plurality of access points 19 on the second face 18. Each access point 19 on the second face 18 is electrically coupled to a corresponding simulator contact 16 on the first face 14. Each access point 19 is also electrically coupled to an embedded capacitor 40 which is electrically coupled to a voltage plane 42 (e.g., ground or a power voltage).

In certain embodiments, the second face 18 is substantially parallel to the first face 14. In certain embodiments, the second face 18 is generally planar, but other forms of the second face 18 (e.g., stepped, angled, or curved) are also compatible with embodiments described herein. In certain embodiments, the access points 19 comprise solder balls, pins, pads, or other forms of conductive terminals. The access points 19 of certain embodiments are arranged on the second face 18 in a pattern similar to the arrangement of the simulator contacts 16 on the first face 14. In certain other embodiments, the access points 19 are arranged on the second face 18 in a pattern different from the arrangement of the simulator contacts 16 on the first face 14. In certain embodiments, the access points 19 are directly above the corresponding simulator contacts 16, while in other embodiments, the positions of the access points 19 are offset from the positions of the corresponding simulator contacts 16. The pattern and positions of the access points 19 in certain embodiments is chosen to advantageously facilitate making electrical connection with the access points 19 to probe the voltages thereon.

FIGS. 5A and 5B schematically illustrate additional embodiments of a load simulator 10 embedded within the printed circuit board 34 of the memory module 30. The embedded load simulator 10 of FIGS. 5A and 5B comprises a plurality of embedded capacitors 40 in the printed circuit board 34 of the memory module 30. Each embedded capacitor 40 is electrically coupled to a conductive line 36 of the printed circuit board 34. Each embedded capacitor 40 has a capacitance approximately equal to the load capacitance of a corresponding device contact 22 of one or more memory devices 20 being simulated. The embedded load simulator 10 of FIG. 5B further comprises a plurality of access points 19 on the printed circuit board 34. Each access point 19 is electrically coupled to a corresponding conductive line 36 of the printed circuit board 34. In certain embodiments, embedded load simulators 10, such as those schematically illustrated by FIGS. 5A and 5B, simulate the load of one or more memory devices 20.

Providing Access to Signal and Address Voltages

Validation of a memory module 30 is typically performed by probing the voltages (e.g., signals and addresses) received by the memory devices 20 while mounted on the memory module 30. However, for certain types of memory device packages (e.g., BGA, μBGA), it is difficult to validate the memory module 30 since the device packages block access to the solder-ball device contacts 22 and the module contacts 32 beneath the memory device 20.

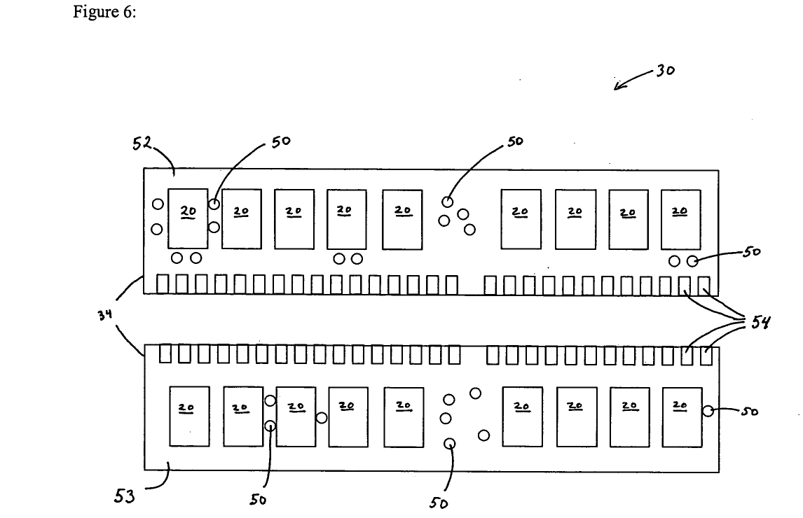

Typical memory modules 30 provide test points 50 on the printed circuit board 34 to provide access to, and allow probing of, a limited number of these voltages. FIG. 6 schematically illustrates two views of a typical memory module 30 with a first side 52 and a second side 53. The memory module 30 has a plurality of memory devices 20 and a plurality of test points 50. These test points 50 are electrically coupled to conductive lines 36 which connect the input terminals (i.e., device contacts 22) of the memory devices 20 to the board contacts 54 of the printed circuit board 34. The test points 50 are typically placed close to the device contacts 22 but outside the footprint of the memory devices 20.

However, the additional portions of the conductive lines 36 which electrically couple these test points 50 to the device contacts 22 have capacitances. Therefore, the voltages probed at the test points 50 are not accurate representations of the voltages at the device contacts 22 to which they are electrically coupled. In certain configurations, such voltage measurements can be construed to be indicative of erroneous data or as uncertainties in the design quality of the memory module 20.

If “dummy” memory device packages which do not simulate the capacitances of the memory device 20 are used, the loading differences between such “dummy” packages and the actual memory device 20 can cause inaccuracies in the probed voltages or their timing. For example, such loading differences can cause a good module design to fail, or can cause a bad module design to appear to be acceptable.

In certain embodiments, at least one load simulator 10 is mounted on the memory module 30 in place of at least one memory device 20. The load simulator 10 of certain embodiments comprises a plurality of simulator contacts 16 on a first face 14 of the load simulator 10 and a plurality of access points 19 on a second face 18 of the load simulator 10, as schematically illustrated by FIGS. 4A and 4B. The access points 19 are electrically coupled to the simulator contacts 16 and to a plurality of embedded capacitors 40. Mounting the at least one load simulator 10 on the memory module 30 comprises electrically coupling the plurality of simulator contacts 16 to the printed circuit board 34. Electrical signals from the memory module 30 are then measured in certain embodiments at the plurality of access points 19.

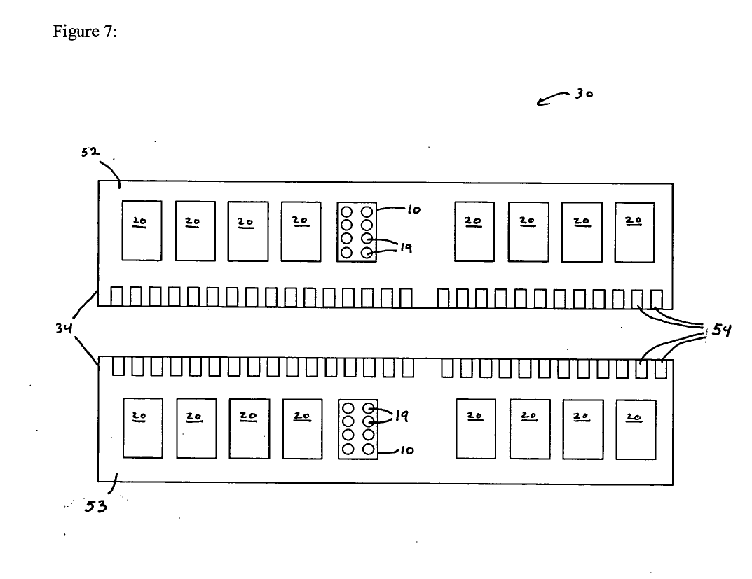

In the embodiment schematically illustrated by FIG. 7, a load simulator 10 is installed in place of one of the memory devices 20 of the rank of memory on the first side 52 of the memory module 30. In addition, a load simulator 10 is installed in place of one of the memory devices 20 of the rank of memory on the second side 53 of the memory module 30. In certain embodiments, a rank of memory includes all the memory devices 20 accessed by a single “SELECT” signal.

In certain embodiments, the load simulator 10 is installed in place of one or more of the error correction chip (ECC) memory devices 20 of the memory module 30. By disabling the system error checking or reporting, certain such embodiments are advantageously used to perform live signal integrity checks without compromising system use of all memory. In certain embodiments, substantially all of the address and control bits for the rank, including the rank select CS#, can be probed. Certain such embodiments can be used for verification of ECC data bits or write strobe voltages.

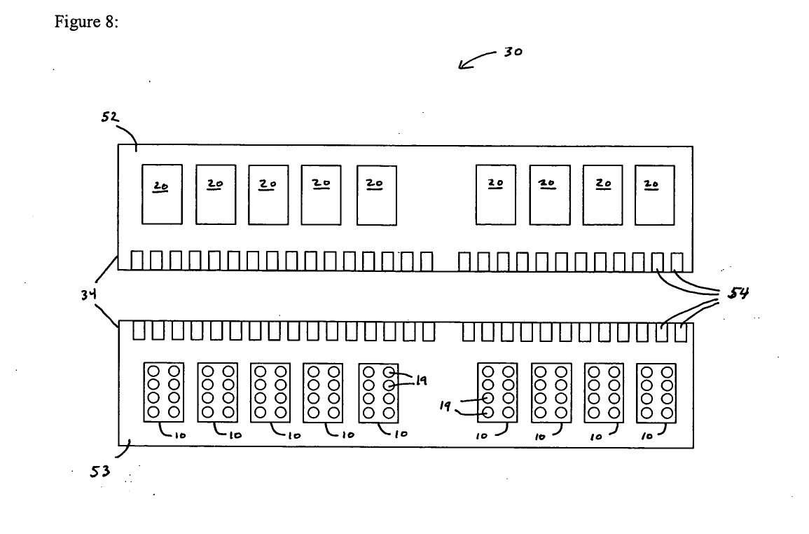

In the embodiment schematically illustrated by FIG. 8, load simulators 10 are installed in place of each of the memory devices 20 of the rank of memory on the second side 53 of the memory module 30. Certain such embodiments advantageously provide access to all the module contacts 32 corresponding to the replaced rank of memory, so that the memory module 30 can be probed and verified. Since no memory devices 20 are present in the rank, the replaced rank is disabled in certain embodiments by making appropriate changes to the data in the serial-presence-detect (SPD) device of the memory module 30.

In certain embodiments, all of the module connects 32 of the memory module 30 are populated by load simulators 10. Such embodiments advantageously allow testing of other computer system hardware without utilizing actual memory modules 30. For example, such embodiments can be used for validation of register or phase-locked-loop (PLL) voltages.

In certain embodiments, access to the voltages on the conductive lines 36 of the printed circuit board 34 is provided by mounting one or more load simulators 10 having access points 19 and which are configured to be electrically coupled to the module contacts 32, such as those schematically illustrated by FIGS. 4A and 4B, to the memory module 30 in place of one or more memory devices 20. In certain other embodiments, access to these voltages is provided by one or more load simulators 10 with access points 19 and which are embedded in the printed circuit board 34 of the memory module 30, as schematically illustrated by FIG. 5B.

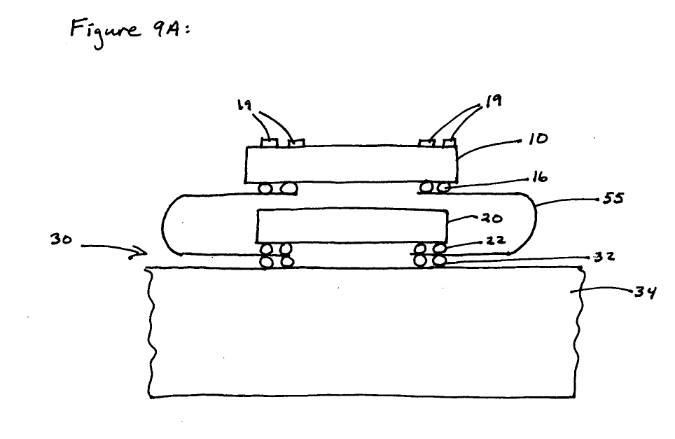

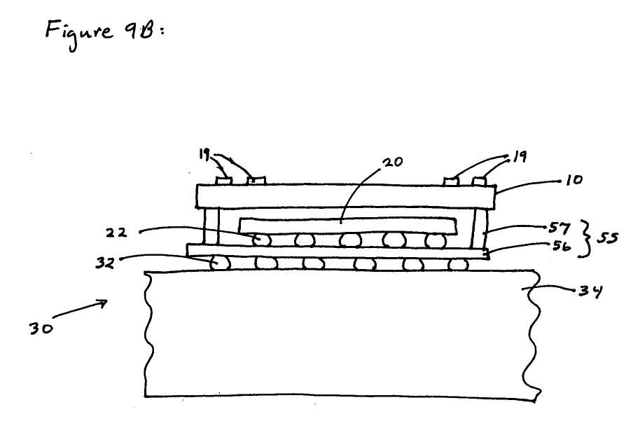

In the embodiment schematically illustrated by FIG. 9A, a memory module 30 utilizes stacked top and bottom memory devices 20. The load simulator 10 has access points 19 and simulator contacts 16 and is stacked with a bottom memory device 20 in place of the top memory device 20 of the pair. The simulator contacts 16 are electrically coupled to the device contacts 22 of the memory device 20 by an interconnect assembly 55. In certain such embodiments, the load simulator 10 provides access to voltages which would be received by the top memory device 20 if it had been installed on the memory module 30. The load simulator 10 advantageously provides a truer representation of the voltages that are received by a top memory device 20 since these voltages can be probed at the terminus where the top memory module 20 is to be mounted without the disruption caused by noise and electrical interference prevalent when test stubs are used. In certain embodiments, a load simulator 10 is stacked with a memory device 20, as schematically illustrated by FIG. 9A. In other embodiments, two load simulators 10 are stacked together to simulate stacked top and bottom memory devices 20.

In the embodiment schematically illustrated by FIG. 9B, the interconnect assembly 55 comprises an interposer 56 between the module contacts 32 and the device contacts 22. Conductive elements 57 (e.g., posts) provide electrical connection of the device contacts 22 of the memory device 20 and the simulator contacts 16 of the load simulator 10.

Mimicing Additional Functionality

In certain embodiments, the load simulator 10 incorporates additional circuitry to mimic additional functionality of the memory devices 20. FIG. 10 schematically illustrates an exemplary circuit 60 of a load simulator 10 for simulating on-die termination (ODT) of a DDR2 memory device 20. Other load simulators 10 simulate one or more other functional features of the memory device 20 in accordance with embodiments described herein.

ODT of a memory device 20 places the signal termination on the memory device 20 rather than on the motherboard. The ODT function can be enabled or disabled by two bits in the extended mode register set (EMRS1) of commands, and is designed to improve signal integrity by allowing the memory controller to independently turn off/on termination resistance for any or all memory devices 20. In certain embodiments, the circuit 60 schematically illustrated by FIG. 10 advantageously monitors EMRS1 commands, latches the ODT strength settings, and asserts ODT with synchronous timing.

The circuit 60 comprises a plurality of flip-flops 62, a decode/latch 64 of the EMRS1, a plurality of field-effect transistors (FETs) 66, and a plurality of termination resistors 68 (e.g., each having a resistance of 150 ohms). Table 3 provides the termination resistance of the ODT as a function of the input voltages A2 and A6 of the EMRS1.

TABLE 3

| A6 | A2 | A | B | C | Termination Resistance (ohms) |
|---|---|---|---|---|---|
| 0 | 0 | — | — | — | OFF |
| 0 | 1 | ON | ON | — | 75 |
| 1 | 0 | ON | — | — | 150 |
| 1 | 1 | ON | ON | ON | 50 |

The capacitance of the DQ input terminal of a memory device 20 varies depending on the ODT state of the memory device 20. The load simulator 10 schematically illustrated by FIG. 10 has an input terminal 70 corresponding to the DQ input terminal of the memory device 20 and a capacitor 72 electrically coupled to the input terminal 70. The total capacitance of the input terminal 70 of the load simulator 10 varies to mimic the varying capacitance of the DQ input terminal of the memory device 20 being simulated.

In an exemplary embodiment, the capacitance of the DQ input terminal being simulated by the load simulator 10 varies, depending on the ODT state of the memory device 20, to be approximately 1 picofarad, 2 picofarads, 3 picofarads, or a maximum load capacitance Cₘₐₓ of 4 picofarads. To achieve a load capacitance on the input terminal 70 which mimics the load capacitance on the DQ input terminal of the memory device 20, the capacitor 72 has a capacitance Cᵢₒ given by: Cᵢₒ=Cₘₐₓ−3*(C_{FET}). In an exemplary embodiment in which the capacitance C_{FET} of each FET 66 is approximately equal to 1 picofarad and Cₘₐₓ is approximately equal to 4 picofarads, Cᵢₒ is approximately equal to 1 picofarad.

Load Matching

Mismatched loading between memory modules 30 of a computer system can cause significant complexity in the design and qualification of the computer system. For example, in an address bus of an unbuffered dual in-line memory module (UDIMM), some memory modules may have 8 or 9 memory devices (i.e., loads), while other memory modules have 16 or 18 loads, and still other memory modules may have 36 loads. These variations in the loading of the various memory modules can cause variations in the input slew rates of the memory modules.

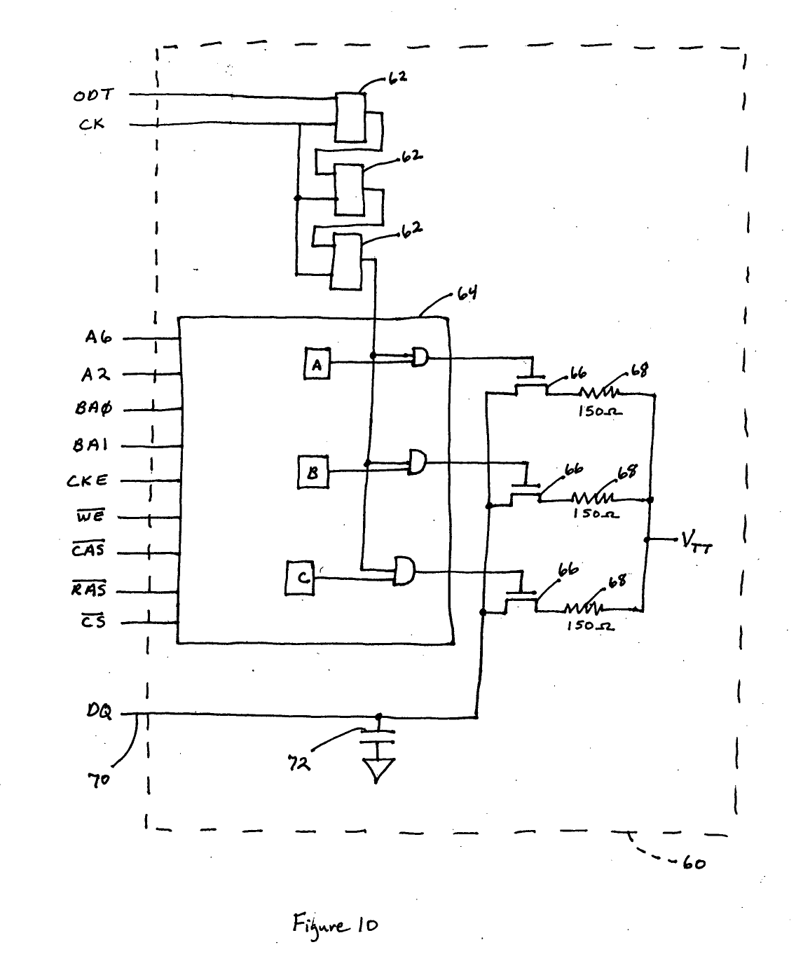

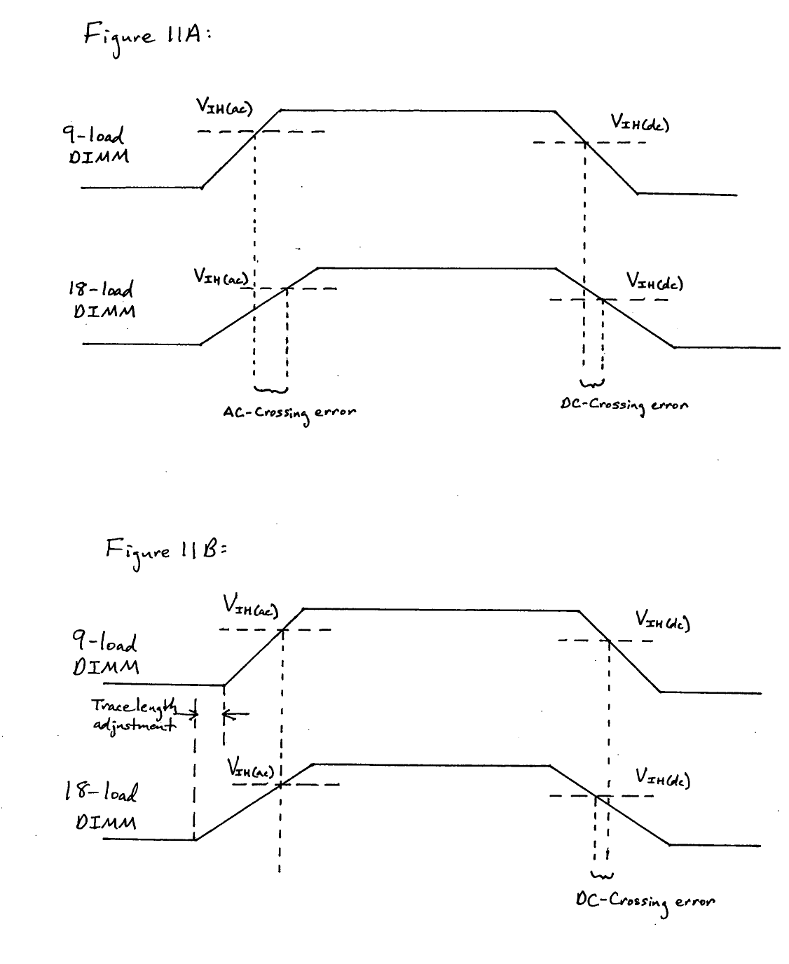

FIG. 11A schematically illustrates an exemplary slew rate mismatch between two exemplary memory modules: a 9-load DIMM and an 18-load DIMM. For address and control signals, the high-level AC crossing voltage (“V_{IH(ac)}”) is a voltage above which the signal will be recognized as a high-level signal if the signal reaches that voltage an adequate amount of time before the clock edge. Similarly, the low-level AC crossing voltage (“V_{IL(ac)}”) for address and control signals is a voltage below which the signal will be recognized as a low-level signal if the signal reaches that voltage an adequate amount of time before the clock edge. An AC-crossing error results from the different times for signals to cross the AC crossing voltages of the two memory modules. FIG. 11A schematically illustrates the AC-crossing error for a high-level signal.

For address and control signals, the high-level DC crossing voltage (“V_{IH(dc)}”) is a voltage above which the signal will be recognized as a high-level signal if the signal remains above that voltage an adequate amount of time after the clock edge. Similarly, the low-level DC crossing voltage (“V_{IL(dc)}”) for address and control signals is a voltage below which the signal will be recognized as a low-level signal if the signal remains below that voltage an adequate amount of time after the clock edge. Typically, the DC crossing voltages are closer to the signal midpoint (defined as the power source voltage divided by two) than are the AC crossing voltages. A DC-crossing error results from the different times for the signals to cross the DC crossing voltages of the two memory modules. FIG. 11A schematically illustrates the DC-crossing error for a low-level signal.

The address and control input setup time (“tIS”) is the time period between the clock edge and all the signals of a group (e.g., all address inputs) crossing the AC crossing voltage. The address and control input hold time (“tIH”) is the time period between the clock edge and at least one of the signals crossing the DC crossing voltage. Similarly, the data input setup time (“tDS”) is the time period between the strobe edge and all the data signals of a group crossing the AC crossing voltage. The data input hold time (“tDH”) is the time period between the strobe edge and at least one of the data signals crossing the DC crossing voltage. The setup time tIS and the hold time tIH (as well as tDS and tDH) are affected by AC and DC crossing errors.

With large memory modules, the traditional solution is to make the timing of lightly-loaded memory modules compatible with the timing of heavily-loaded memory modules by adding conductive trace length to the lightly-loaded memory modules. The added trace length causes changes of the propagation times that compensate for the slower rise and fall times of the heavily-loaded signals. The added trace length does not appreciably change the capacitance of the conductive trace.

FIG. 11B schematically illustrates the slew rates for the 9-load DIMM with trace length adjustments as compared to the 18-load DIMM of FIG. 1A. Adding conductive trace length to the 9-load DIMM reduces the mismatch of the propagation time at the AC crossing with the 18-load DIMM by increasing the propagation time of the signal. However, the slew rate remains unchanged since the added trace length does not appreciably change the capacitance of the conductive trace. Therefore, a DC-crossing error remains. Such trace length adjustments can reduce the mismatch for the setup time tIS or the hold time tIH, but not for both. In certain such situations, the AC crosspoint is assumed to be more significant to the internal bit trigger, so trace length adjustments are used to reduce the AC-crossing error.

However, with very small memory modules, it is not always possible to increase the trace lengths to accomplish this compatibility due to space constraints. In such situations, surface-mounted capacitors have previously been used in place of the added trace length. However, it is impractical to place a surface-mounted capacitor on the memory module for every end point of every signal. To overcome this impracticality, memory modules have previously been designed with one side branch per signal, with groups of four side branches each electrically coupled to a corresponding surface-mounted capacitor which is used for the load for the four signals. Such an approach reduces the number of surface-mounted capacitors by a factor of four (e.g., from 96 surface capacitors to 24 surface capacitors).

Certain embodiments described herein advantageously avoid using these surface-mounted capacitors by using one or more load simulators 10 to match the loads of various memory modules 30 in a computer system. Certain embodiments utilize an embedded load simulator 10 with embedded capacitors 40 in the printed circuit board 34 of the memory module 30 to match the loads of lightly-loaded memory modules and heavily-loaded memory modules. Because the capacitors are embedded within the printed circuit board 34, such embedded load simulators 10 do not need to create groups of signal lines connected to a common capacitor. For example, 96 embedded capacitors 40 can be used, thereby advantageously providing better performance than the 24 surface-mounted capacitors. In addition, the embedded load simulator 10 of certain embodiments simulates the load of a plurality of memory devices 20.

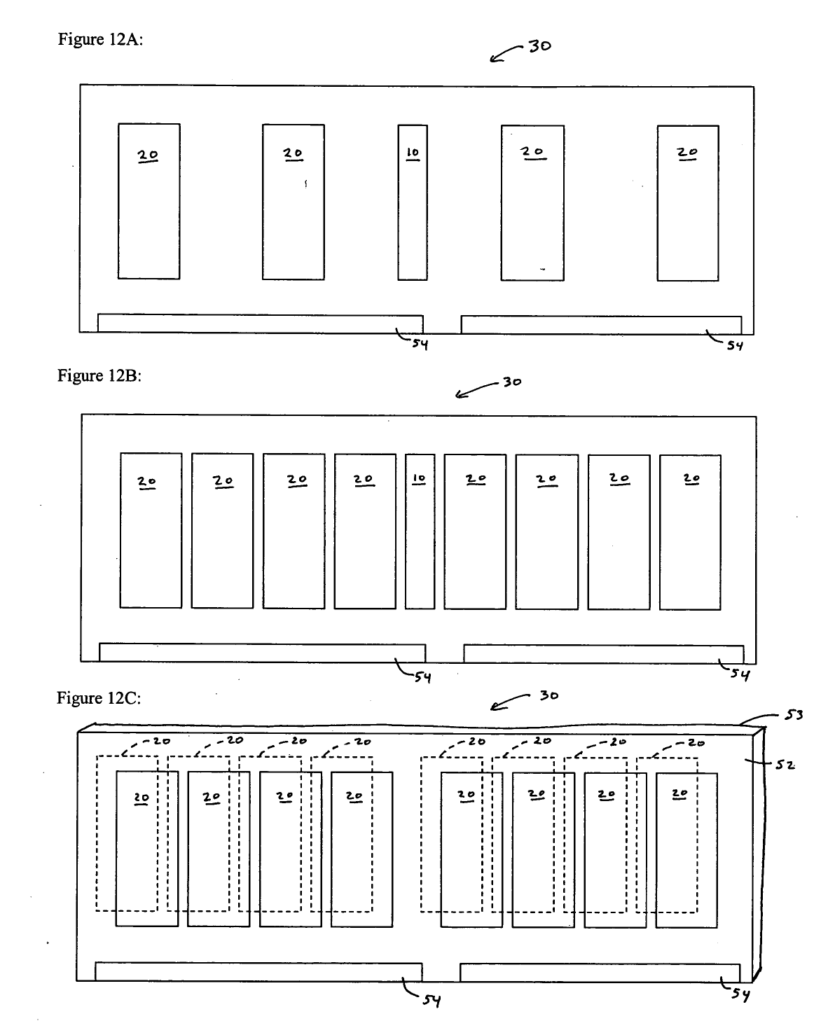

FIG. 12A schematically illustrates a lightly-loaded memory module 30 with an embedded load simulator 10 in the printed circuit board 34 in accordance with embodiments described herein. The lightly-loaded memory module 30 has four memory devices 20 and the embedded load simulator 10 simulates the load of 12 memory modules 30. Thus, the lightly-loaded memory module 30 of FIG. 12A has an effective load equal to that of a memory module 30 with 16 memory devices 20, as schematically illustrated by FIG. 12C (which has two ranks of eight memory devices 20 on each of two sides 52, 53 of the memory module 30).

FIG. 12B schematically illustrates a medium-loaded memory module 30 with an embedded load simulator 10 in the printed circuit board 34 in accordance with embodiments described herein. The medium-loaded memory module 30 has eight memory devices 20 and the load simulator 10 simulates the load of 8 memory modules 30. Thus, the medium-loaded memory module 30 of FIG. 12B also has an effective load equal to that of the memory module 30 of FIG. 12C with 16 memory devices 20.

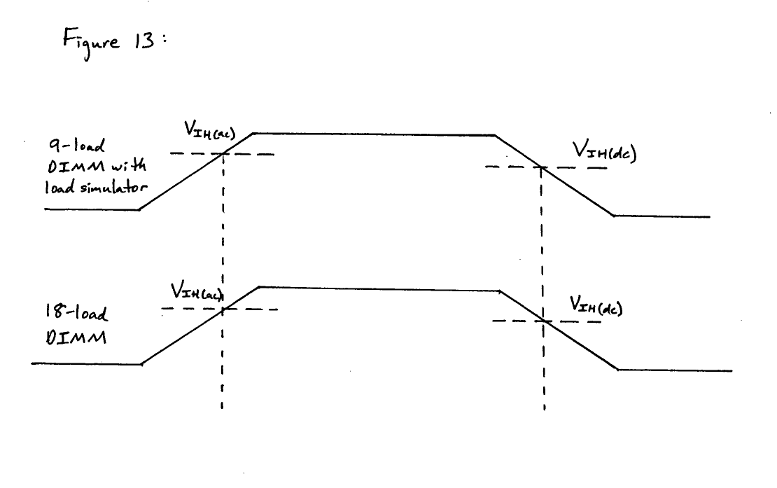

FIG. 13 schematically illustrates the slew rates for the 9-load DIMM with an embedded load simulator 10 (simulating the load from 9 memory devices 20) as compared to the 18-load DIMM of FIG. 11A. The additional capacitance on the conductive traces due to the embedded load simulator 10 alters the slew rates of the 9-load DIMM to effectively match the slew rates of the 18-load DIMM. In certain embodiments, the embedded load simulator 10 advantageously normalizes the input slew rate of a memory module 30 with fewer memory devices 20 to effectively match the input slew rates of other memory modules with more memory devices 20. In certain embodiments, the memory module 30 with at least one load simulator 10 avoids the additional conductive trace lengths used in standard memory modules. Such memory modules 30 with one or more load simulators 10 advantageously have the same setup time tIS and the same hold time tIH as other memory modules with more memory devices. The one or more load simulators 10 of certain embodiments also provide access points 19 to allow probing of the voltages of the memory module 30.

Bit Width Equivalence

Some computer systems are designed to be compatible with memory modules 20 having a specified bit width. For example, certain computer systems (e.g., servers) are designed to be compatible with a bit width of 72 bits per memory module, each memory module 30 having nine memory devices 20 with eight bits each. In certain such computer systems, the last eight bits are used for error correction chip (ECC) capabilities. However, certain other computer systems (e.g., desktop computers) do not use ECC capabilities and utilize memory modules 30 with 64 bits per memory module, each memory module 30 having eight memory devices 20 with eight bits each.

Printed circuit boards 34 for 72-bit memory modules 30 can be designed to optimize the signal timing and the signal integrity for such 72-bit memory modules 30 (e.g., by designing the signal and address lines). If these printed circuit boards 34 are used instead for 64-bit memory modules 20 by removing one memory device 20 (and its corresponding eight bits), then the signal timing and the signal integrity is degraded (e.g., due to signal reflections and/or electrical interference contributing to the noise).

In certain embodiments, a memory module 30 has a first bit width. The memory module 30 comprises a first number of memory devices 20. The memory module 30 further comprises a printed circuit board 34. The printed circuit board 34 is optimized for use with a second number of memory devices 20 to form a second bit width greater than the first bit width. The first number of memory devices 20 are electrically coupled to the printed circuit board 34. The memory module 30 further comprises at least one load simulator 10 electrically coupled to the printed circuit board 34. The load simulator 10 has a load approximately equal to a load of a third number of memory devices 20. The second number equals a sum of the first number and the third number. By eliminating unwanted reflections along the conductive lines of the printed circuit board 34, certain embodiments described herein utilize the load simulator 10 to advantageously improve the signal timing and signal integrity of the memory module 30.

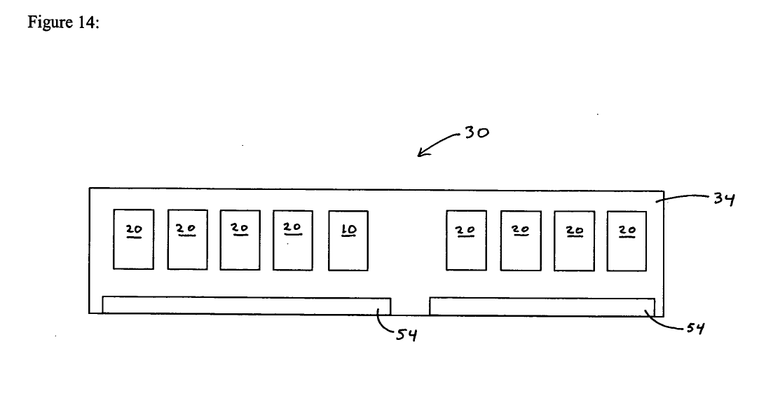

FIG. 14 schematically illustrates an exemplary embodiment of the memory module 30 with a first bit width of 64 bits and eight memory devices. Each of the eight memory devices 20 has eight bits. However, the printed circuit board 34 of FIG. 14 is optimized for use as part of a 72-bit memory module 30 with nine memory devices 20, each memory device 20 having eight bits. The memory module 30 further comprises a load simulator 10 which has a load approximately equal to one memory device 20. By simulating the load of the missing memory device 20, the 64-bit memory module 30 utilizes the load simulator 10 to maintain the signal timing and the signal integrity of a 72-bit memory module for which the printed circuit board 34 was optimized. Other values of the first bit width, first number, second bit width, second number, and third number are compatible with embodiments described herein.

Load Balancing

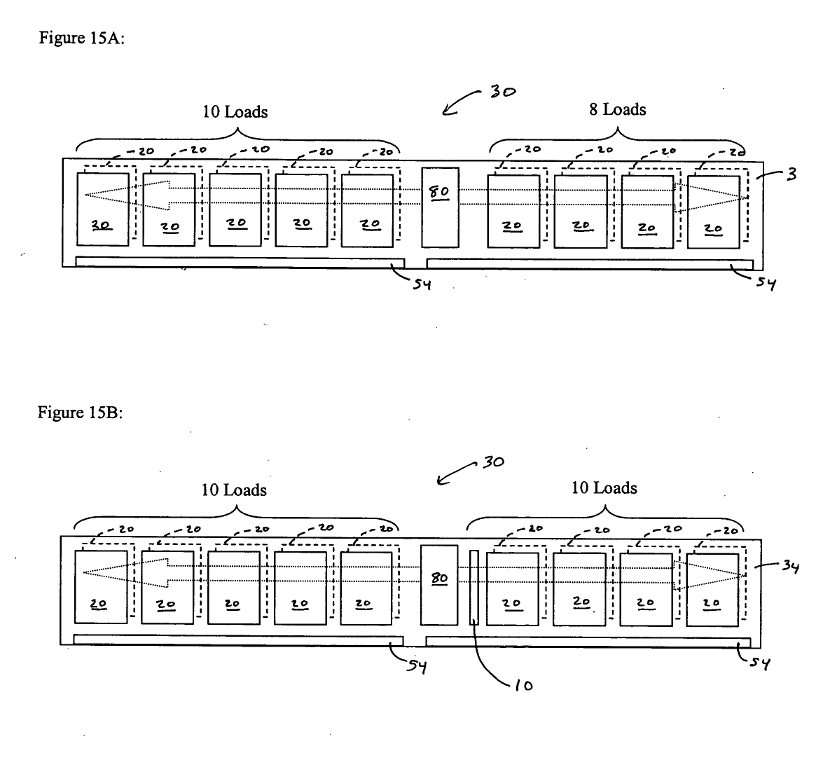

FIG. 15A schematically illustrates a memory module 30 having 18 memory devices 20, a printed circuit board 34 with a first side and a second side, a set of board contacts 54, and a register 80 with a ratio of inputs to outputs of 1:2. The memory devices 20 are arranged in two ranks of 9 memory devices 20 each on each side of the printed circuit board 34. The memory devices 20 are electrically coupled to the register 80. For memory modules 30 with an odd number of memory devices 20 on each side of the printed circuit board 34, it can be difficult to balance the loads on each side of the register 80, especially for small memory modules 30 with a limited amount of available area. For example, as schematically illustrated by FIG. 15A, there are ten loads on one side of the register 80 and eight loads on the other side of the register 80. This loading imbalance causes the outputs of the register 80 on the two sides of the register 80 to exhibit different timing.

FIG. 15B schematically illustrates one embodiment in which at least one load simulator 10 is used to balance the loads on the two sides of the register 80. The memory module 30 of FIG. 15B comprises the same number (i.e., 18) of memory devices 20 as does the memory module 30 of FIG. 15A. However, the memory module 30 further comprises at least one load simulator 10 on one side of the register 80. The load simulator 10 of FIG. 15B simulates the load capacitance of two memory devices 20. In this way, the load simulator 10 advantageously balances the loads on either side of the register 80. In certain such embodiments, the timing on the two sides of the register 80 exhibit the same timing, including rise and fall times and setup and hold times. Other numbers of memory devices 20, registers 80, and loads being simulated by the at least one load simulator 10 are compatible with embodiments described herein.

Various embodiments of the present invention have been described above. Although this invention has been described with reference to these specific embodiments, the descriptions are intended to be illustrative of the invention and are not intended to be limiting. Various modifications and applications may occur to those skilled in the art without departing from the true spirit and scope of the invention as defined in the appended claims.

1. A load simulator configured to simulate a load characteristic of at least one memory device, the memory device having a plurality of device contacts configured to be electrically coupled to a plurality of module contacts on a printed circuit board of a memory module, each device contact having a load capacitance, the load simulator comprising:
a package having a first face; and
a plurality of simulator contacts on the first face, the simulator contacts configured to be electrically coupled to the module contacts, each simulator contact having a simulator capacitance approximately equal to the load capacitance of a corresponding device contact of the at least one memory device.

2. The load simulator of claim 1, wherein each device contact of a first set of the device contacts has a first load capacitance and each device contact of a second set of the device contacts has a second load capacitance different from the first load capacitance.

3. The load simulator of claim 1, wherein the simulator capacitance of each simulator contact is approximately equal to a sum of the load capacitances of the corresponding device contacts of a plurality of memory devices, thereby simulating the load capacitances of the plurality of memory devices.

4. The load simulator of claim 1, further comprising a plurality of embedded capacitors electrically coupled to the plurality of simulator contacts.

5. The load simulator of claim 4, further comprising a plurality of embedded resistors electrically coupled to the plurality of simulator contacts.

6. The load simulator of claim 4, further comprising a plurality of embedded inductors electrically coupled to the plurality of simulator contacts.

7. The load simulator of claim 1, wherein the plurality of module contacts and the plurality of simulator contacts are compatible with a ball-grid-array (BGA) configuration, a micro-ball-grid-array (μBGA) configuration, or a thin small-outline package (TSOP) configuration.

8. The load simulator of claim 1, further comprising additional circuitry which mimics one or more functional features of the memory device.

9. The load simulator of claim 8, wherein the at least one functional feature comprises on-die termination.

10. The load simulator of claim 1, wherein the memory module comprises a dual in-line memory module (DIMM).

11. The load simulator of claim 1, wherein the at least one memory device comprises a dynamic random-access memory (DRAM) device.

12. The load simulator of claim 1, wherein the at least one memory device comprises a dual-data-rate-1 (DDR1) memory device or a dual-data-rate-2 (DDR2) memory device.

13. The load simulator of claim 1, wherein the package further comprises a second face, the load simulator further comprising a plurality of access points on the second face, each access point electrically coupled to a corresponding simulator contact.

14. A load simulator configured to simulate the load characteristics of at least one memory device, the memory device having a plurality of device contacts configured to be electrically coupled to a plurality of conductive lines of a printed circuit board of a memory module, each device contact having a load capacitance, the load simulator comprising:
a plurality of embedded capacitors in the printed circuit board, each embedded capacitor electrically coupled to a conductive line of the printed circuit board, each embedded capacitor having a capacitance approximately equal to the load capacitance of a corresponding device contact of the at least one memory device.

15. The load simulator of claim 14, wherein each device contact of a first set of the device contacts has a first load capacitance and each device contact of a second set of the device contacts has a second load capacitance different from the first load capacitance.

16. The load simulator of claim 14, wherein the capacitance of each capacitor is approximately equal to a sum of the load capacitances of the corresponding device contacts of a plurality of memory devices, thereby simulating the load capacitances of the plurality of memory devices.

17. The load simulator of claim 14, further comprising a plurality of embedded resistors electrically coupled to the plurality of conductive lines.

18. The load simulator of claim 14, further comprising a plurality of embedded inductors electrically coupled to the plurality of conductive lines.

19. The load simulator of claim 14, wherein the plurality of device contacts is compatible with a ball-grid-array (BGA) configuration, a micro-ball-grid-array (μBGA) configuration, or a thin small-outline package (TSOP) configuration.

20. The load simulator of claim 14, further comprising additional circuitry which mimics one or more functional features of the memory device.

21. The load simulator of claim 20, wherein the at least one functional feature comprises on-die termination.

22. The load simulator of claim 14, wherein the memory module comprises a dual in-line memory module (DIMM).

23. The load simulator of claim 14, wherein the at least one memory device comprises a dynamic random-access memory (DRAM) device.

24. The load simulator of claim 14, wherein the at least one memory device comprises a dual-data-rate-1 (DDR1) memory device or a dual-data-rate-2 (DDR2) memory device.

25. The load simulator of claim 14, wherein the load simulator further comprises a plurality of access points on the printed circuit board, each access point electrically coupled to a corresponding conductive line.

26. A method for testing a memory module having a printed circuit board and a plurality of memory devices mounted on the printed circuit board, each memory device having a plurality of device contacts electrically coupled to the printed circuit board with each device contact having a load capacitance, the method comprising:
providing a load simulator comprising:
a package having a first face and a second face;
a plurality of access points on the first face; and
a plurality of simulator contacts on the second face, each simulator contact electrically coupled to a corresponding access point, each simulator contact having a simulator capacitance approximately equal to the load capacitance of a corresponding device contact of the memory device;
electrically coupling the plurality of simulator contacts to the printed circuit board; and
measuring electrical signals from the memory module at the plurality of access points.

27. A memory module having a first bit width, the memory module comprising:
a first number of memory devices;
a printed circuit board optimized for use with a second number of memory devices to form a second bit width greater than the first bit width, the first number of memory devices electrically coupled to the printed circuit board; and
at least one load simulator electrically coupled to the printed circuit board, the load simulator having a load approximately equal to a load of a third number of memory devices, the second number equal to a sum of the first number and the third number.

28. The memory module of claim 27, wherein:
the first bit width is 64;
the second bit width is 72;
each memory device has a bit width of eight bits;
the first number is eight;
the second number is nine; and
the third number is one.
